(19) United States
(12) Patent Application Publication
(10) Pub. No.: US 2016/0100217 A1
(43) Pub. Date: Apr. 7, 2016

(54) SYSTEM AND METHOD FOR OPTIMIZING DELIVERY OF VIDEO CONTENT IN NATIVE MOBILE APPLICATIONS

(71) Applicant: StreamRail Ltd., Tel Aviv (IL)

(72) Inventors: Or HILTCH, Rishon LeZion (IL); Guy ZIPORI, Kfar Saba (IL)

(73) Assignee: StreamRail Ltd., Tel Aviv (IL)

(21) Appl. No.: 14/872,623

(22) Filed: Oct. 1, 2015

Related U.S. Application Data
(60) Provisional application No. 62/058,409, filed on Oct. 1, 2014.

(51) Int. Cl. H04N 21/443; H04N 21/239; H04N 21/462; H04N 21/4782; H04L 29/06; H04N 21/61

(52) U.S. Cl. CPC H04N 21/4431; H04L 65/608; H04N 21/6125; H04N 21/6175; H04N 21/4622; H04N 21/4782; H04N 21/2393

(57) ABSTRACT

A system and method for optimizing content delivery via native applications. The method comprises: intercepting a request for a content item existing in a web source over a network, wherein the request is intercepted from a user device; analyzing the intercepted request to extract a pointer to the web source; analyzing the web source to identify at least one content node communicatively connected to the network, wherein each of the at least one identified content node provides a more efficient delivery of the content item than the web source; causing the user device to select a content node of the at least one identified content node; and causing the user device to retrieve the content item via the selected content node.

### CROSS-REFERENCE TO RELATED APPLICATIONS

This application claims the benefit of U.S. Provisional Application No. 62/058,409 filed on Oct. 1, 2014, the contents of which are hereby incorporated by reference.

### TECHNICAL FIELD

The present disclosure relates generally to providing video content over a network, and more particularly to providing video content through native applications executed on a mobile device.

### BACKGROUND

Traffic over the world-wide-web (WWW) using the Internet continues to grow rapidly. Additionally, the complexity and size of information transferred has grown rapidly in recent years. Bottlenecks in the transport of data from content suppliers to end users have become a significant challenge that delays the transfer of information and decreases the quality of user experiences. Such traffic is expected to continue increasing faster than the ability to resolve data transfers over the Internet.

In particular, end users have increasingly begun using applications on mobile devices (e.g., smart phones) to obtain content and in particular video content. Examples include applications for news, videos, images, social media, and so on. Among these applications, users seek to maximize performance of the applications by using native applications that are designed for compatibility with their devices. A native application is typically designed to optimally interact with software on user devices, frequently require interaction with external content servers, content delivery networks, which are not typically optimized to ensure that content and in particularly video content is not always delivered to native application in most efficiently.

It would therefore be advantageous to provide an efficient solution for enabling content delivery via native applications.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

The disclosed embodiments include a method for optimizing content delivery via native applications. The method comprises: intercepting a request for a content item existing in a web source over a network, wherein the request is intercepted from a user device; analyzing the intercepted request to extract a pointer to the web source; analyzing the web source to identify at least one content node communicatively connected to the network, wherein each of the at least one identified content node provides a more efficient delivery of the content item than the web source; causing the user device to select a content node of the at least one identified content node; and causing the user device to retrieve the content item via the selected content node.

The disclosed embodiments also include a system for optimizing content delivery via native applications. The system comprises: a processing unit; and a memory, the memory containing instructions that, when executed by the processing unit, configure the system to: intercept a request for a content item existing in a web source over a network, wherein the request is intercepted from a user device; analyze the intercepted request to extract a pointer to the web source; analyze the web source to identify at least one content node communicatively connected to the network, wherein each of the at least one identified content node provides a more efficient delivery of the content item than the web source; cause the user device to select a content node of the at least one identified content node; and cause the user device to retrieve the content item via the selected content node.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a flowchart illustrating a method for optimizing delivery of web content according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments allows for optimizing content, such as video content delivery via native applications. Specifically, in an exemplary and non-limiting embodiment, an optimization is achieved by serving the content requested by a native application (app) from alternative sources different that the source selected initially requested by the native application.

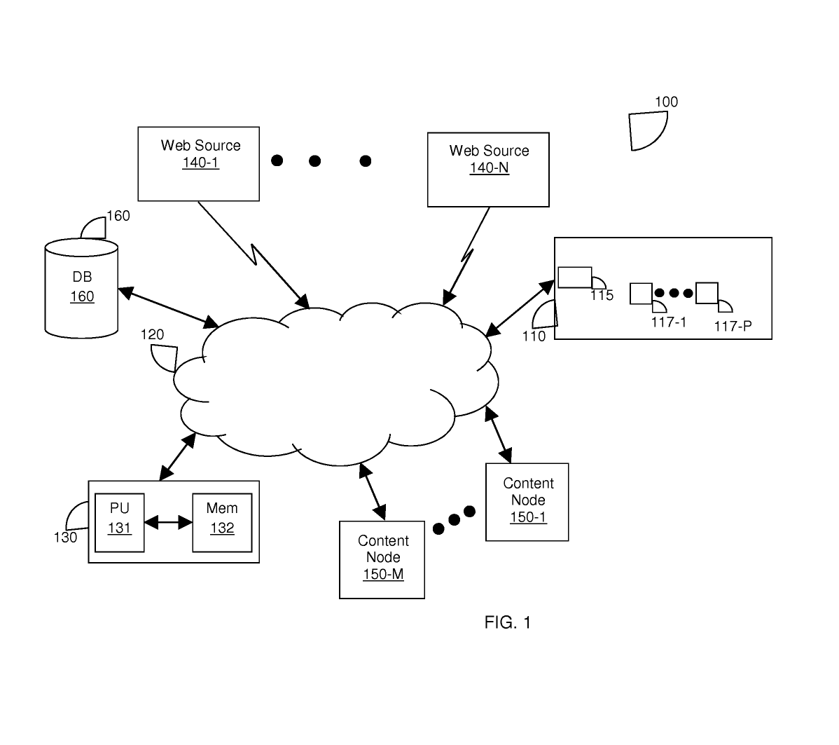

FIG. 1 shows an exemplary and non-limiting network diagram 100 utilized to describe the various disclosed embodiments. A user device 110 is communicatively connected to a network 120. The network 120 may be, but is not limited to, a local area network (LAN), a wide area network (WAN), a metro area network (MAN), the world wide web (WWW), the Internet, a wired network, a wireless network, and the like, as well as any combination thereof. The user device 110 may be, but is not limited to, a smart phone, a mobile phone, a laptop, a tablet computer, a personal computer (PC), a wearable computing device, a smart television, and so on. The user device 110 includes a plurality of native applications (apps) 117-1 through 117-P (hereinafter referred to individually as an application 117 or collectively as applications 117, merely for simplicity purposes) installed therein. Each native application 117 is typically downloaded from a central repository and installed on the user device 110. A native application 117 is programmed to interact with the computing resources of the user device 110 as well as external web resource that provides content for the native application. Examples for web resources are provided below.

An agent 115 is installed on the user device 110. The agent 115 may be a software code (e.g., an application) installed in a memory (not shown) of the user device 110 and executed by a processing unit (not shown) of the user device 110. In an embodiment, instead of the agent 115, a script (not shown) supported natively by a browser of the user device 110 may be utilized.

In an embodiment, the agent 115 is communicatively connected to a server 130 through the user device 110. The server 130 includes a processing unit (PU) 131 connected to a memory (mem) 132. The memory 132 contains instructions that, when executed by the processing unit 131, configures the server to perform the embodiments disclosed herein. In an embodiment, the server 130 may configure the agent 115 to perform the embodiments disclosed herein.

The server 130 is configured to identify and intercept a request sent from at least one of the native applications 117 (e.g., the application 117-1) to obtain video content. As a non-limiting example, the request may be for a video clip to be displayed while a user of the user device 110 plays a game via a game application (e.g., application 117-3) installed on the user device 110, such a request is triggered upon reaching a specific point in the game. The requested video clip is stored as a content item in a web resource of a plurality of web resources 140-1 through 140-N (hereinafter referred to individually as a web source 140 or collectively as web sources 140, merely for simplicity purposes). Each of the web sources 140 may be, but is not limited to, a remote server, a data center, a content delivery network (CDN), a web-page, and so on. A content item may include, but is not limited to, video content such as a video stream, a video clip, a video frame, and so on.

Typically, a request initiated by the application requesting the content contains information at least respective of one of the web sources 140 such as, e.g., the web source 140-1. The server 130 is configured to intercept the request and extract a pointer to the web source 140-1 embedded therein. A pointer may be in the form of a URL. The server 130 is further configured to cause the user device 110 to identify one or more content nodes of a plurality of content nodes 150-1 through 150-M (hereinafter referred to individually as a content node 150 and collectively as content nodes 150, merely for simplicity purposes) based on the extracted pointer and/or the web source 140-1. Such an identification may be performed by the server 130.

A content node 150 may be any device communicatively connected to the network 120 which is configured to receive content from a web source 140 and to serve such content to the user device 110. As a non-limiting example, the content node 150-1 may be a user device (different from the user device 110) installed with a native application (such as the native application 117) and preferably with the agent 115.

Specifically, in an embodiment, the content node 150 identified to serve part or all of the requested content is a content node that previously retrieved part or all of the requested content from the web source 140-1. The identification of such requested content may include, but is not limited to, scanning the tags (e.g., HTML tags) included in the requested content and matching such scanned tags to tags of previously served content to identify at least one content node 150 that previously retrieved part or all of the content. Alternatively or collectively, a content node 150 may be identified by mapping the communication patterns of the web source 140-1 and/or any shareable portions of the web-source 140-1 along with their respective identifiers.

In an exemplary embodiment, the mapping of communication patterns (e.g., mapping webpages to resources) includes mapping an identifier to each shareable portion of the web source 140-1 respective of a content node or content nodes 150. As a non-limiting example, an ID may be a URL, a title of the web-page, or a combination thereof.

Shareable portions of a web-source may be, but are not limited to, a web content item (e.g., a video or a portion thereof), a file containing at least one web content item, and so on. In a further embodiment, each shareable portion of the web-source 140-1 may include a cryptographic hash (e.g., a SHA1 hash) associated with the shareable portion. In an embodiment, when a user device 110 accesses a shareable portion of the web-source 140-1, the server 130 is configured to send a map of all content resources from which the requested content can be downloaded or retrieved to the user device 110. The content resources may include the web-sources 140 and/or the content nodes 150. The server 130 is also configured to connect to the user device 110 on a channel that designates all cryptographic hashes of all such content resources. This channel can be realized as a WebSocket channel.

Once the user device 110 has downloaded the requested content, the user device 110 can serve as a content node 150. That is, the user device 110 (acting as a content node) may be added to a subscriber list of content resources which accessed content having the cryptographic hash. When another user device (not shown) subsequently attempts to access content previously downloaded or requested by the user device 110 (now acting as a content node), the server 130 is configured to cause the user device 110 to notify the other user device through the WebSocket channel, as both devices are subscribed to this channel.

The server 130 is configured to cause the user device 110 to select at least one of the identified content nodes 150 such as, but not limited to, the content node 150-1. A content node 150-1 is selected to serve the requested content when serving the requested content through the selected content node 150-1 would be more efficient than serving the requested content through the web source 140-1. In an embodiment, the selected content node 150-1 is a content node that previously requested the content now being requested by the user device 110.

That is, the selected content node 150-1 is selected so as to optimize the transfer of the content item. In an embodiment, the selection may be based on, but not limited to, existence of a portion of the content item on the selected content node 150-1, availability of the selected content node 150-1 and of the web source 140-1, relative load on each of the selected content node 150-1 and the web source 140-1, geographic location of the selected content node 150-1 and of the web source 140-1 relative to the user device 110, and/or a trust history of the selected content node. A trust history of the selected content node may include, but is not limited to, information related to previous sessions in which the selected content node accessed and/or attempted to access any of the web sources 140. Such session history may be utilized to determine whether the selected content node is a reliable source for serving the requested content.

Thus, the selected content node 150-1 is selected upon determining that the transfer of the content item via the selected content node 150-1 would be more efficient than transfer of the content item via the web source 140-1. As a non-limiting example, if it is determined that the load on the selected content node 150-1 is less than the load on the web source 140-1, the selected content node 150-1 may be selected.

Upon selection of a content node, the server 130 is configured to cause the user device 110 to retrieve the requested content item from the web source 140-1. In an embodiment, the content item may be retrieved using a web real-time communication (webRTC) application programming interface (API). The webRTC is enabled by initializing web browsers embedded natively on the user device 110 such as, for example, a Webview component. That is, in an embodiment, the server 130 is configured to cause the selected content node 150-1 to establish a real-time peer-to-peer connection with the user device 110, to provide or stream the requested content to the user device 110.

In an embodiment, establishing a real-time peer-to-peer connection may include, but is not limited to, causing the user device 110 to send a request to the selected content node 150-1, causing the selected node 150-1 to send a response to the request, and causing the selected content node 150-1 and the user device 110 to establish the connection. The request and/or the response to the request may include information related to the sharing capabilities (e.g., types of files or data that can be sent) and/or technical properties (via, e.g., session description protocol IP) of each of the selected content node 150-1 and the user device 110. In an embodiment, upon establishment of the connection, the server 130 is configured to establish a data channel (e.g., a webRTC data channel) between the selected content node 150-1 and the user device 110.

Alternatively, the webRTC is enabled by accessing the applications 117 and crawling the communications by the applications 117 with respective web sources 140. This crawling enables extraction of the data needed to retrieve the requested content.

It should be noted that the webRTC connection can be opened with more than one content node. The server 130 can be configured to control the timing for establishing the webRTC connection. It should be further noted that the requested content can be provided in part by one more alternate content nodes and in part by the web source 140, thereby combined providing the completed requested web content.

Data gathered respective of the web sources 140, the content nodes 150, and any requests sent by the user device 110 may be stored in a database (DB) 160 communicatively connected to the server 130 over the network 120. In an embodiment, to validate that the content is available through the selected content node 150-1, the server 130 is configured to retrieve and analyze content. Based on the analysis, the content item may be validated. Such validation may be required, for example, to detect malicious code, viruses, and so on. In an embodiment, the server 130 is configured to only cause the user device 110 to retrieve the content item if the validation is successful.

As a non-limiting example, a request for video clip existing in a web source 140-1 from a user device 110 is intercepted by the server 130. The request for the video clip may include a URL identifying the location of the requested video clip. For example, the URL may be https://www.youtube.com/watch?v=62LGgkdTpB4. Based on the intercepted request and, in particular, the URL, the server 130 may identify content nodes 150 that have previously accessed the requested video clip.

The request may include additional data related to the user device 110. For example, such data may include, but is not limited to, a type of the user device 110, an operating system type, metadata associated with the native application requesting the information (e.g., application ID or name, version number, etc.), and so on.

From the URL, at least the web source can be identified as You Tube®, while the video clip ID is “62LGgkdTpB4”. Based on the pointer (URL), the server 130 may cause the user device 110 to select a content node 150-1 for the at least a portion of the requested video content. For example, the selection may be based on the video clip ID and/or on the requesting application's metadata. If such content node is selected, the server 130 causes the at least a portion of the video item to be streamed to the user device 110 via a webRTC API through the selected content node 150-1, thereby shortening the initialization time of the video clip display.

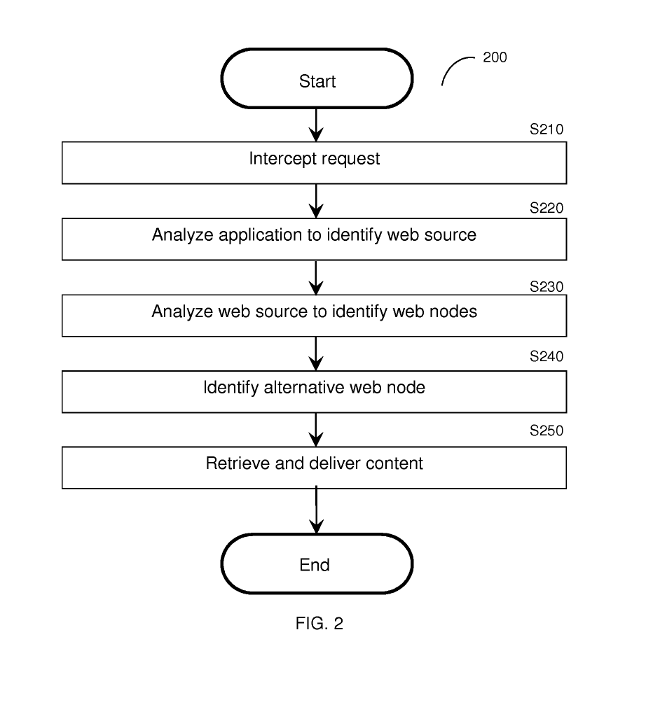

FIG. 2 is an exemplary and non-limiting flowchart 200 illustrating a method for optimizing delivery of web content according to an embodiment. In an embodiment, the steps of the flowchart 200 may be performed by a server (e.g., the server 130) or may be performed by an agent (e.g., the agent 115) installed on a user device (e.g., the user device 110) and configured by the server. In S210, a request for a content item existing in a web source (e.g., the web source 140) is intercepted. The request may be made by an application (e.g., the application 117) installed on a user device (e.g., the user device 110) over a network (e.g., the network 120). The request contains information related to the web source for providing the requested content. The application is typically programmed with a destination web source to retrieve the information from.

In S220, the request is analyzed to extract at least a pointer to the web source. In S230, the web source pointed by the extracted pointer is analyzed to identify one or more content nodes (e.g., the content nodes 150) that have previously requested the content item from the web source.

In S240, the user device is caused to select at least one content node to provide the content item to the user device. The selected content node is selected so as to optimize delivery of the content item. In an embodiment, the selection may be based on, but not limited to, any of: existence of a portion of the content item on the selected content node, availability of the selected content node and of the analyzed web source, relative load on each of the selected content node and the analyzed web source, geographic location of each of the selected content node and the analyzed web source relative to the user device, a trust history of the selected content node, combinations thereof, and so on.

In S250, the user device is instructed to retrieve the requested content from the selected content node. As noted above, in one embodiment, the content retrieval is enabled through a webRTC API.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for optimizing content delivery via native applications, comprising:
intercepting a request for a content item existing in a web source over a network, wherein the request is intercepted from a user device;
analyzing the intercepted request to extract a pointer to the web source;
analyzing the web source to identify at least one content node communicatively connected to the network, wherein each of the at least one identified content node provides a more efficient delivery of the content item than the web source;
causing the user device to select a content node of the at least one identified content node; and
causing the user device to retrieve the content item via the selected content node.

2. The method of claim 1, wherein the selection of the selected content node is based on any of: existence of a stored portion of the content item on the selected content node, relative availability of each of the selected content node and the web source, relative load on each of the selected content node and the web source, geographic location of each of the selected content node and of the web source relative to the user device, and a trust history of the selected content node.

3. The method of claim 1, wherein the content item is retrieved using a web real-time communication (webRTC) application programming interface (API).

4. The method of claim 3, further comprising:
initializing at least a web browser embedded in the user device to establish a connection with the selected content note using the web real-time communication application programming interface.

5. The method of claim 1, wherein analyzing the web source to identify at least one content node communicatively connected to the network further comprises:
mapping an identifier to each shareable portion of the analyzed web source; and
sending a map including the mapped identifiers to the user device.

6. The method of claim 5, wherein each shareable portion is any of: a web content item, and a file including at least one web content item.

7. The method of claim 6, wherein each shareable portion further includes a cryptographic hash.

8. A non-transitory computer readable medium having stored thereon instructions for causing one or more processing units to execute the method according to claim 1.

9. A system for optimizing content delivery via native applications, comprising:
a processing unit; and
a memory, the memory containing instructions that, when executed by the processing unit, configure the system to:
intercept a request for a content item existing in a web source over a network, wherein the request is intercepted from a user device;
analyze the intercepted request to extract a pointer to the web source;
analyze the web source to identify at least one content node communicatively connected to the network, wherein each of the at least one identified content node provides a more efficient delivery of the content item than the web source;
cause the user device to select a content node of the at least one identified content node; and
cause the user device to retrieve the content item via the selected content node.

10. The system of claim 9, wherein the selection of the selected content node is based on any of: existence of a stored portion of the content item on the selected content node, relative availability of each of the selected content node and the web source, relative load on each of the selected content node and the web source, geographic location of each of the selected content node and of the web source relative to the user device, and a trust history of the selected content node.

11. The system of claim 9, wherein the content item is retrieved using a web real-time communication (webRTC) application programming interface (API).

12. The system of claim 11, wherein the system is further configured to:
initialize at least a web browser embedded in the user device to establish a connection with the selected content note using the web real-time communication application programming interface.

13. The system of claim 9, wherein the system is further configured to:
map an identifier to each shareable portion of the analyzed web source; and
send a map including the mapped identifiers to the user device.

14. The system of claim 13, wherein each shareable portion is any of: a web content item, and a file including at least one web content item.

15. The system of claim 14, wherein each shareable portion further includes a cryptographic hash.
